(19) United States
(12) Patent Application Publication
(10) Pub. No.: US 2024/0111516 A1
(43) Pub. Date: Apr. 4, 2024

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Kazuya YAMAMOTO, Toklyo (JP)

(73) Assignee: NEC Corporation, Tokyo (JP)

(21) Appl. No.: 18/370,463

(22) Filed: Sep. 20, 2023

(30) Foreign Application Priority Data
Sep. 30, 2022 (JP) 2022-157304

(51) Int. Cl. G06F 8/65; G06F 9/48

(52) U.S. Cl. CPC G06F 8/65; G06F 9/4881

(57) ABSTRACT

An information processing apparatus including: a detection unit that detects, when a computer needs to be restarted in applying a security patch to software that supports a multi-session model and is accessed and used by a plurality of users, one or more non-use periods that are equal to or longer than a time required for the restart and in which none of the users are using the computer, using information regarding the time required for the restart and use history information indicating use histories of the respective users of the computer; and a restart instruction unit that sets a restartable period to a period later than a current point of time based on the detected one or more non-use periods, and gives an instruction for restarting the computer in the restartable period.

### CROSS-REFERENCE TO RELATED APPLICATION

This application is based upon and claims the benefit of priority from Japanese patent application No. 2022-157304, filed on Sep. 30, 2022, the disclosure of which is incorporated herein in its entirety by reference.

### BACKGROUND OF THE INVENTION

### 1. Field of the Invention

The present disclosure relates to an information processing apparatus, an information processing method, and a program.

### 2. Background Art

Among VDI (Virtual Desktop Infrastructure) services, DaaS (Desktop as a Service) is known as a service for deploying a desktop environment on a cloud. In addition, the DaaS model provides a single-session model and a multi-session model. AVD (Azure Virtual Desktop: registered trademark) and the like are known multi-session models.

With the single-session model, an OS (Operating System) that supports the single-session model is installed in each virtual machine constructed on a virtual infrastructure (hypervisor). In addition, in a system that employs the single-session model, one user (one thin client terminal apparatus) is allocated to one virtual machine. Furthermore, the single-session OS provides this thin client terminal apparatus with a virtual desktop that is compatible therewith.

In contrast, with the multi-session model, an OS that supports the multi-session model is installed in each virtual machine constructed on a virtual infrastructure. In addition, in a system that employs the multi-session model, the thin client terminal apparatuses of a plurality of users are allocated to one virtual machine. Furthermore, the multi-session OS provides a virtual desktop to each of the thin client terminal apparatuses connected to the virtual machine in which the multi-session OS is installed.

Therefore, in the multi-session model, the users of the plurality of thin client terminal apparatuses connected to the virtual machine in which the multi-session OS is installed perform various uses. For this reason, when a security patch that requires a restart is applied to the multi-session OS, use by the users is affected if the restart timing is not appropriate.

As a related technique, Japanese Patent Laid-Open Publication No. 2019-087010 discloses a restart control system that includes an information processing apparatus and a restart management apparatus. The restart management apparatus sets a restart time of the information processing apparatus based on apparatus management information that includes information regarding the information processing apparatus and another information processing apparatus that is in a proximal relationship with the information processing apparatus. In addition, the restart management apparatus transmits restart times to the information processing apparatuses. Furthermore, the information processing apparatuses execute a restart at the transmitted restart times.

However, in the restart control system in Japanese Patent Laid-Open Publication No. 2019-087010, restart times of a plurality of information processing apparatuses that are in a proximal relationship are merely set to different times in consideration of the positional relation therebetween.

That is to say, the restart control system in Japanese Patent Laid-Open Publication No. 2019-087010 is not directed toward reducing the influence on users as much as possible when a security patch that requires a restart is applied to an OS that supports the multi-session model.

### SUMMARY

An example object of the present disclosure is to reduce the influence on users when a security patch that requires a restart is applied to software that supports a multi-session model.

In order to achieve the above object, an information processing apparatus according to one aspect of the present disclosure includes:
a detection unit that detects, when a computer needs to be restarted in applying a security patch to software that supports a multi-session model and is accessed and used by a plurality of users, one or more non-use periods that are equal to or longer than a time required for the restart and in which none of the users are using the computer, using information regarding the time required for the restart and use history information indicating use histories of the respective users of the computer; and
a restart instruction unit sets a restartable period to a period later than a current point of time based on the detected one or more non-use periods, and gives an instruction for restarting the computer in the restartable period.

Also, in order to achieve the above object, an information processing method according to one aspect of the present disclosure is performed by an information processing apparatus, the method comprising:
detecting, when a computer needs to be restarted in applying a security patch to software that supports a multi-session model and is accessed and used by a plurality of users, one or more non-use periods that are equal to or longer than a time required for the restart and during which none of the users are using the computer, using information regarding the time required for the restart and use history information indicating use statuses of the respective users of the computer; and
setting a restartable period to a period later than a current point of time based on the detected one or more non-use periods, and giving an instruction for restarting the computer in the restartable period.

Furthermore, in order to achieve the above object, a computer-readable recording medium according to one aspect of the present disclosure includes a program recorded thereon, the program including instructions that causes a computer to carry out:
detecting, when a computer needs to be restarted in applying a security patch to software that supports a multi-session model and is accessed and used by a plurality of users, one or more non-use periods that are equal to or longer than a time required for the restart and in which none of the users are using the computer, using information regarding the time required for the restart and use history information indicating use statuses of the respective users of the computer; and
setting a restartable period to a period later than the current point of time based on the detected one or more non-use periods, and giving an instruction for restarting the computer in the restartable period.

As described above, according to the present disclosure, when a security patch that requires a restart is applied to software that supports the multi-session model, influence on users can be reduced.

### BRIEF DESCRIPTION OF THE DRAWINGS

FIG. 1 is a diagram illustrating an example of the information processing apparatus according to the first example embodiment.

FIG. 2 is a diagram for describing a method for setting a restartable period.

FIG. 3 is a diagram for describing an example of a system that includes the information processing apparatus according to the first example embodiment.

FIG. 4 is a diagram for describing the configuration of the information processing apparatus in detail.

FIG. 5 is a diagram for describing an example of the data structure of the use history information.

FIG. 6 is a diagram for describing a method for detecting non-use periods.

FIG. 7 is a diagram for describing operations of the information processing apparatus according to the first example embodiment.

FIG. 8 is a diagram illustrating an example of the information processing apparatus according to the second example embodiment.

FIG. 9 is a diagram for describing an example of the data structure of the non-use detection rule information.

FIG. 10 is a diagram for describing an example of the data structure of the non-use detection rule information.

FIG. 11 is a diagram for describing a method for detecting a suspendable period.

FIG. 12 is a diagram for describing operations of the information processing apparatus according to the second example embodiment.

FIG. 13 is a diagram for describing an example of a computer that realizes the information processing apparatus the information processing apparatus according to the first and second example embodiments.

### EXEMPLARY EMBODIMENTS

Hereinafter, example embodiments will be described with reference to the drawings. Note that, in the drawings described below, elements having the same functions or corresponding functions are denoted by the same reference numerals, and repeated description thereof may be omitted.

### First Example Embodiment

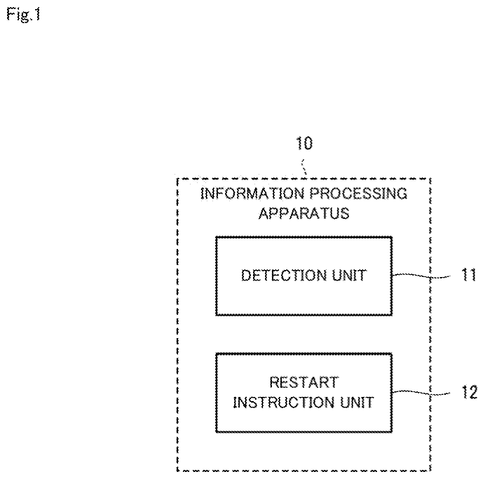

A configuration of an information processing apparatus 10 according to a first example embodiment will be described with reference to FIG. 1. FIG. 1 is a diagram illustrating an example of the information processing apparatus according to the first example embodiment.

[Apparatus Configuration]

When a security patch that requires a restart is applied to software that supports a multi-session model, the information processing apparatus 10 shown in FIG. 1 applies the security patch, and restarts a computer so as not to affect use by users. In addition, as shown in FIG. 1, the information processing apparatus 10 includes a detection unit 11 and a restart instruction unit 12.

In applying a security patch to multi-session software that is accessed and used by a plurality of users, if the computer needs to be restarted, the detection unit 11 detects one or more non-use periods that are equal to or longer than the time required for a restart and during which none of the users were using the computer, using restart required time information indicating the time required for a restart and use history information indicating the use histories of the respective users of the computer.

The computer may be a virtual machine, hardware, or the like installed in the information processing apparatus 10, for example. Note that a case will be described below in which the computer is a virtual machine.

The multi-session model is a method for allowing a plurality of users to share and use multi-session software that is implemented in a virtual machine or the like. Note that the multi-session model may be realized by the DaaS model.

The multi-session software is an OS or application software that supports the multi-session model and is installed in a virtual machine or the like. Note that, hereinafter, application software may be referred to as an “application” or “app”.

The virtual machine is a computer that realizes, with software, similar functions to those of a physical computer. In addition, the virtual machine executes an OS and applications similarly to a physical computer.

The security patch is a program for correcting vulnerability of the multi-session software. There are cases where vulnerability, a security hole, and the like are found in publicly available OSs and applications, and thus, the software is corrected using a security patch in order to protect the information processing apparatus 10 from malware, cyberattacks, and the like. Note that the security patch is distributed by a vendor or the like when vulnerability is found.

The restart instruction unit 12 sets a restartable period to a period later than the current point of time based on the detected non-use periods, and gives an instruction for restarting the virtual machine in the restartable period. The virtual machine then receives the instruction before the restartable period, and corrects the software by applying the security patch to the software installed in the virtual machine based on the received instruction, and restarts the virtual machine in the restartable period.

When, for example, none of the users sharing the virtual machine are using the virtual machine in a period from 8:00 am to 9:00 am on Monday in the past from the current point of time (Monday of the current week), and this period is longer than the time required for a restart (non-use period), the restartable period is set to a period from 8:00 am to 9:00 am on Monday in the future from the current point of time (Monday of next week).

In addition, when, for example, one or more periods in which none of the users sharing the virtual machine were using the virtual machine in the past one week from the current point of time and that are longer than the time required for a restart (non-use periods) are detected, periods in the coming one week from the current point of time that correspond to the plurality of detected periods (periods on the same day at the same time) are set as restartable periods.

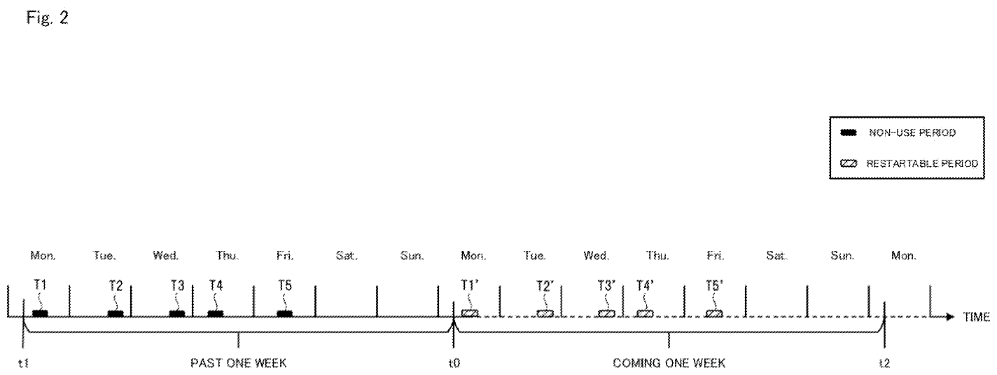

FIG. 2 is a diagram for describing a method for setting a restartable period. In the example in FIG. 2, it is assumed that the current time t0 is 8:00 am on Monday, and that as a result of detecting non-use periods in the past one week from 8:00 am on Monday of last week (time t1) until the current time t0, non-use periods T1, T2, T3, T4, and T5 were detected.

In this case, in the example in FIG. 2, the detected non-use periods T1 to T5 are allocated to the coming one week from the present time t0 to 8:00 am on Monday of next week (time t2), based on the day and time, and restartable periods T1′, T2′, T3′, T4′, and T5′ are obtained.

The reason for setting a plurality of restartable periods is that there are cases where a restart cannot be performed in the restartable period T1′, and, in that case, the restart is desirably performed in the next restartable period T2′.

In addition, it is preferable to apply a security patch promptly, and thus it is desirable that restartable periods are selected in order from the restartable period that is closest to the present time t0.

Furthermore, when a plurality of restartable periods are set for a security patch, settings of the restartable periods are cancelled after a restart is performed in order to apply the security patch.

As described above, in the first example embodiment, when a security patch that requires a restart is applied to multi-session software, restartable periods are set based on non-use periods detected using restart required time information (information regarding the time required for a restart) and use history information, and the virtual machine is restarted in a restartable period, and thus it is possible to restart the virtual machine without affecting users.

[System Configuration]

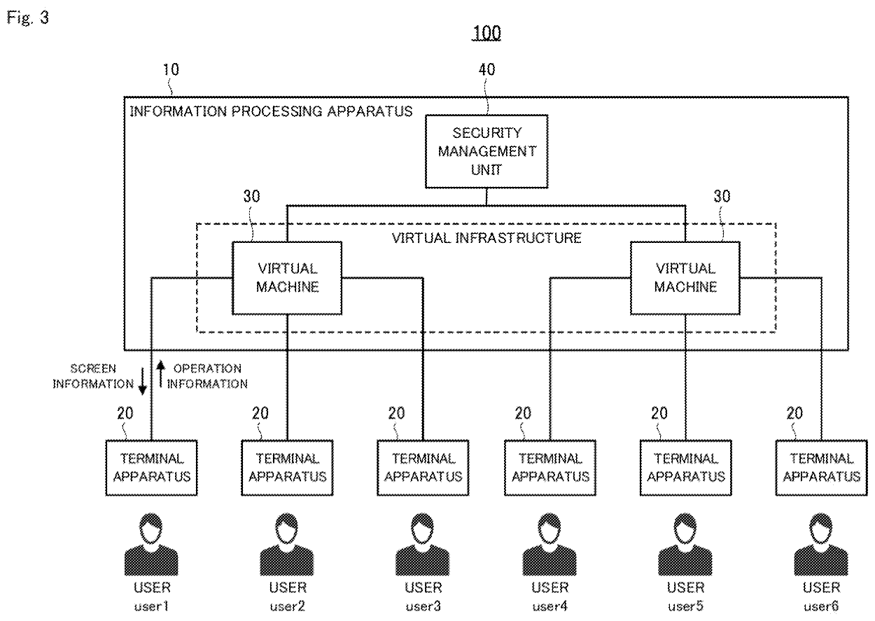

The configuration of the information processing apparatus 10 according to the first example embodiment will be described in more detail with reference to FIG. 3. FIG. 3 is a diagram for describing an example of a system that includes the information processing apparatus according to the first example embodiment.

In the example in FIG. 3, a system 100 includes the information processing apparatus 10 and a plurality of terminal apparatuses 20. In addition, the information processing apparatus 10 is connected to the plurality of terminal apparatuses 20 via a network.

The information processing apparatus 10 is a CPU (Central Processing Unit), a programmable device such as an FPGA (Field-Programmable Gate Array), a GPU (Graphics Processing Unit), a circuit on which one or more thereof are mounted, a server computer, or the like. In addition, the information processing apparatus 10 includes one or more virtual machines 30 and a security management unit 40.

Each terminal apparatus 20 is a CPU, a programmable device such as an FPGA, a GPU, a circuit on which one or more thereof are mounted, a general client terminal apparatus (a personal computer, a tablet, a smartphone, etc.), a thin client terminal apparatus, or the like.

The thin client terminal apparatus is a terminal apparatus obtained by removing a large-capacity storage medium (HDD (Hard Disk Drive), SSD (Solid State Drive)) from a client terminal, for example.

The network is, for example, a general communication network constructed using a communication line such as the Internet, a LAN (Local Area Network), a dedicated line, a phone line, an intranet, a mobile communication network, Bluetooth (registered trademark), Wi-Fi (Wireless Fidelity)(registered trademark), or the like.

The virtual machines 30 are constructed on a virtual infrastructure of the information processing apparatus 10. Each of the virtual machines 30 transmits, to the terminal apparatuses 20, screen information indicating screen content of a virtual desktop that is used by the users. The virtual machine 30 receives, from each terminal apparatus 20, operation information indicating operation content of the terminal apparatus 20 of the user. The operation content is information input from an input device such as a keyboard, a mouse, or a touch panel, for example.

When vulnerability is found in multi-session software installed in the virtual machine 30, the security management unit 40 manages information regarding the security distributed by a vendor. In addition, the security management unit 40 corrects the vulnerability of the software using a security patch, and generates an instruction for restarting the virtual machine 30. The security management unit 40 then transmits the generated instruction to the virtual machine 30.

The information processing apparatus 10 will be described in detail.

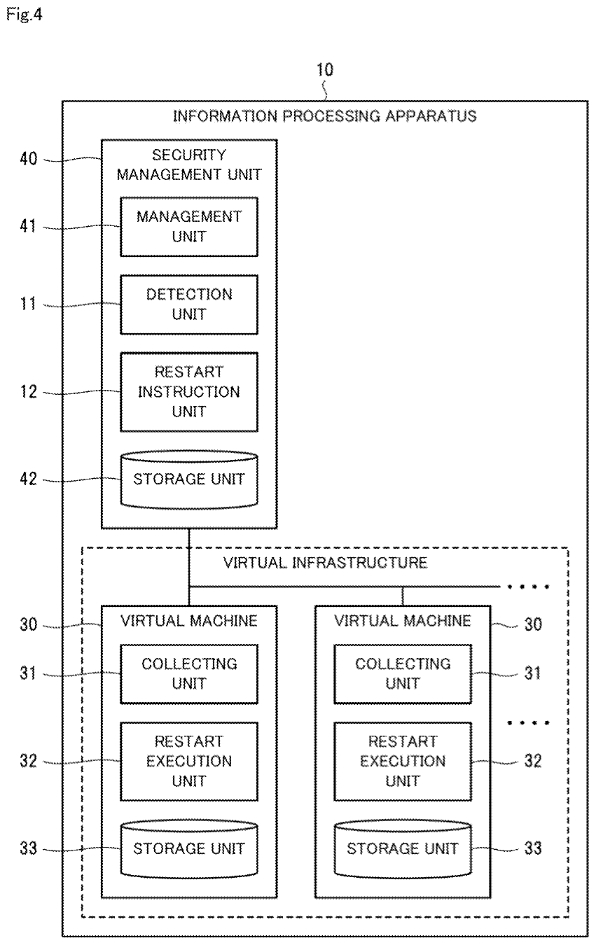

FIG. 4 is a diagram for describing the configuration of the information processing apparatus in detail. In the example in FIG. 4, each of the plurality of virtual machines 30 includes a collecting unit 31, a restart execution unit 32, and a storage unit 33. The security management unit 40 includes a management unit 41, the detection unit 11, the restart instruction unit 12, and a storage unit 42.

Note that, in the example in FIG. 4, the storage unit 33 and the storage unit 42 are separate from each other, but the storage unit 33 and the storage unit 42 may be a single storage unit. Furthermore, in the example in FIG. 4, the storage unit 33 and the storage unit 42 are provided in the information processing apparatus 10, but may be provided outside the information processing apparatus 10.

In addition, in the example in FIG. 4, the collecting unit 31, the restart execution unit 32, and the storage unit 33 are provided in each of the virtual machines 30, but may be provided outside the virtual machine 30.

Description of Virtual Machine 30

The collecting unit 31 collects use history information of the users sharing the virtual machine 30, at an interval set in advance, and stores the use history information to the storage unit 33 for each of the users sharing the virtual machine 30.

The interval set in advance is an interval of a few minutes, a few hours, or the like. Note that the collecting unit 31 may collect use history information using a collecting function of an agent implemented in the virtual machine 30.

In addition, the collecting unit 31 transmits the collected use history information to the security management unit 40. Upon receiving the use history information, the management unit 41 of the security management unit 40 stores, to the storage unit 42, the use history information of each of the users sharing the virtual machine 30. Note that the use history information does not need to be stored in the storage unit 33, and may be stored in the storage unit 42.

The use history information is information obtained by associating user identification information for identifying each user, use specifying information for specifying a use, use period information indicating the period of the use, and operation identification information for identifying an operation performed in the use with each other.

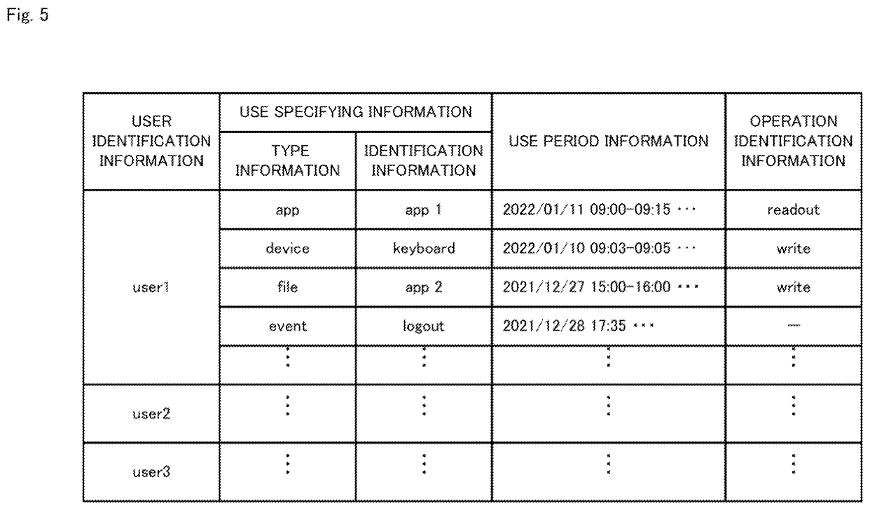

FIG. 5 is a diagram for describing an example of the data structure of the use history information. The example in FIG. 5 shows the use history information of the users (users 1 to 3) of one of the virtual machines 30 shown in FIG. 3. Note that the use history information of the users (users 4 to 6) of another virtual machine 30 shown in FIG. 3 is also stored in the storage unit 33 or 42, similarly to the use history information in FIG. 5.

The user identification information in FIG. 5 stores “user 1”, “user 2”, and “user 3”, namely, information for identifying the users sharing the one virtual machine 30. Note that the number of users sharing the virtual machine 30 is not limited to three.

The use specifying information in FIG. 5 includes type information indicating the type of software, hardware and files used by the user (user 1), and the type of events that occurred due to operations by the user, and identification information for identifying software, hardware, and files used by the user (user 1), events that occurred due to operations by the user, and the like.

The type information stores “app” indicating a type of application (software), “device” indicating a type of input device (hardware), “file” indicating a type of file, “event” indicating a type of event, and the like. Note that the type information is not limited to the above types.

The identification information stores “app 1” indicating that the used application (software) is a communication tool, “keyboard” indicating that the used input device (hardware) is a keyboard, “app 2” indicating that the used file is a file that is used for a table calculation app, “logout” indicating that the event is logout, and the like.

Note that the identification information is not limited to the above “app 1”, “keyboard”, “app 2”, and “logout”.

The use period information in FIG. 5 stores periods “2022/01/11 09:00-09:15”, “2022/01/10 09:03-09:05 . . . ”, and “2021/12/27 15:00-16:00” in which the user used the above application “app 1”, input device “keyboard”, and file “app 2”, respectively, and a time “2021/12/28 17:35 . . . ” when the user logged out.

The operation identification information in FIG. 5 stores “readout” indicating a function process (mode) when the above application “app 1” was executed, “write” indicating a function process (mode) when the input device “keyboard” was used, and “write” indicating a function process (mode) when a file “app 2” was executed. Note that there is no function process (mode) when the event “logout” was executed, and thus, in the example in FIG. 5, “-” is entered.

In addition, the operation identification information in FIG. 5 includes information indicating function processes (modes), but may include information indicating states of use. Information indicating a state of use stores the state of a user such as “phone” or “chat” indicating that the user is talking on the phone or chatting online when the user performs an operation on the application “app 1”, for example. When the user is inputting data by performing an operation on the input device “keyboard”, “input” indicating the state of the user, or the like is stored. When the file “app 2” is opened by the user, “open” indicating a state where the file has been opened by the user, or the like is stored.

Note that the information indicating the states of use is not limited to “phone”, “chat”, “input”, and “open” described above.

Before a restartable period, the restart execution unit 32 receives, from the restart instruction unit 12, an instruction for applying a security patch to the software of a target virtual machine 30 and for restarting the target virtual machine 30 in the restartable period, applies the security patch based on the received instruction, and restarts the virtual machine 30 in the restartable period.

In addition, when restarting the target virtual machine 30, the restart execution unit 32 may notify the terminal apparatuses 20 of all of the users sharing the target virtual machine 30 that the target virtual machine 30 is to be restarted. This is because there is the possibility that the target virtual machine 30 is being used by a user, and thus, it is highly likely that a sudden restart will cause trouble with use. In addition, a notification requesting that files that are being used be stored may be added to the notification.

The storage unit 33 stores use history information of the users sharing the virtual machine 30 collected by the collecting unit 31.

Description of Security Management Unit 40

The management unit 41 obtains, via the network, a security patch distributed from a vendor or the like, and restart required time information regarding the time required for a restart in order to apply the security patch, and stores the security patch and information to the storage unit 42.

If a virtual machine 30 needs to be restarted in order to apply a security patch, the detection unit 11 first obtains the restart required time information (information regarding the time required for a restart), from the storage unit 42. In addition, the detection unit 11 obtains, from the storage unit 42, the use history information of the users sharing the target virtual machine 30.

Next, the detection unit 11 detects one or more non-use periods that are equal to or longer than the time required for a restart and in which none of the users were using the target virtual machine 30, using the restart required time information (information regarding the time required for a restart) and the use history information.

A method for detecting non-use periods will be described.

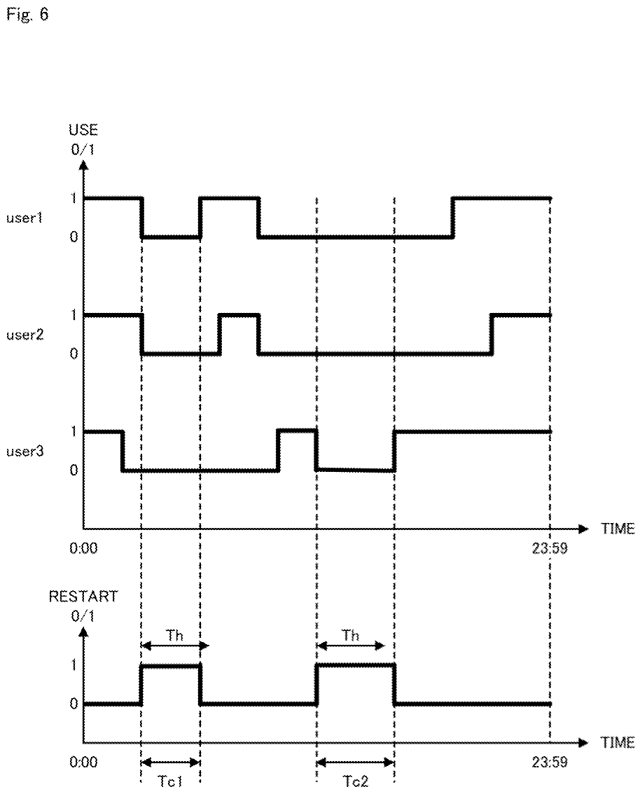

FIG. 6 is a diagram for describing a method for detecting non-use periods. In the example in FIG. 6, the detection unit 11 detects past periods (unused periods) in which the users (users 1 to 3) sharing the virtual machine 30 were not using the virtual machine 30, using the use history information of the users (users 1 to 3).

Specifically, in the case of the users (users 1 to 3), use periods and unused periods of each of the users (users 1 to 3) are obtained. In the case of the user (user 1), for example, a use period and an unused period in a detection period set in advance are obtained using the use history information of the user (user 1).

It is conceivable to use the 24-hour period (0:00 to 23:59) of one of the days in the past one week, as the detection period, for example. In addition, use periods and unused periods in the past one week may be obtained.

In addition, also in the case of the users (users 2 and 3), use periods and unused periods are obtained similarly to the above user (user 1).

Note that, in the example in FIG. 6, a use period and an unused period of each of the users (users 1 to 3) are respectively indicated by “1” and “0”.

Next, the detection unit 11 detects a common unused period in which the unused periods of the users (users 1 to 3) overlap. The example in FIG. 6 indicates that common unused periods Tc1 and Tc2 have been detected.

Next, the detection unit 11 determines whether or not each of the common unused periods Tc1 and Tc2 is equal to or longer than a time Th required for a restart. In the example in FIG. 6, the common unused period Tc1 is shorter than the time Th required for a restart, and thus is not regarded as a non-use period. The common unused period Tc2 is longer than the time Th required for a restart, and thus is regarded as a non-use period.

The restart instruction unit 12 first sets a restartable period based on the non-use period. If, for example, the common unused period Tc2 in FIG. 6 is included in the 24-hour period of Monday of the current week, a period later than the current point of time and corresponding to the common unused period Tc2 on Monday of next week is set as a restartable period. It should be noted that the day of the week is not limited to Monday.

Next, before the restartable period, the restart instruction unit 12 transmits, to the restart execution unit 32 of the virtual machine 30, an instruction for applying a security patch to the software of the virtual machine 30 and for restarting the virtual machine 30.

The storage unit 42 stores at least the security patch, the time that is required for a restart if the security patch is applied, the use history information of the users of the virtual machine 30, and the restartable period.

### Apparatus Operation in First Example Embodiment

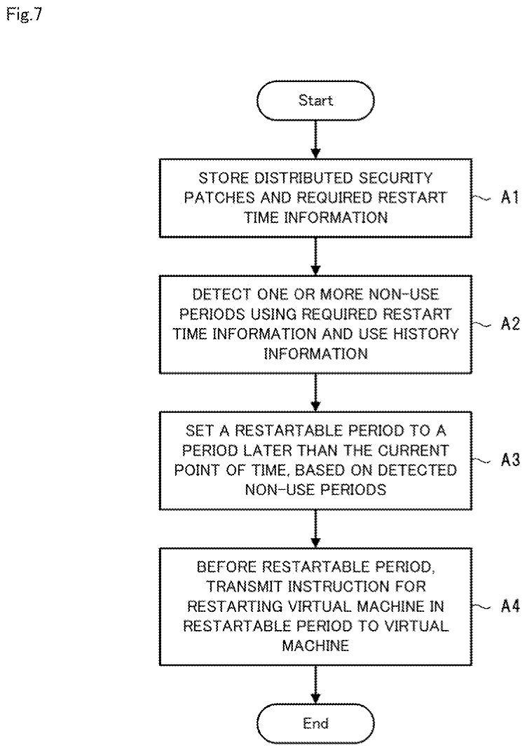

Operations of the information processing apparatus 10 according to the first example embodiment will be described with reference to FIG. 7. FIG. 7 is a diagram for describing operations of the information processing apparatus according to the first example embodiment. In the following description, the diagrams will be referenced as appropriate. In addition, in the first example embodiment, an information processing method is performed by operating the information processing apparatus. Thus, description of the information processing method according to the first example embodiment is replaced with the following description of the operations of the information processing apparatus.

As shown in FIG. 7, first, the management unit 41 obtains a security patch and restart required time information (information regarding the time required for a restart), via the network, and stores the obtained security patch and information to the storage unit 42 (step A1).

Specifically, in step A1, the management unit 41 obtains information regarding security (a security patch and information regarding the time required to restart the virtual machine 30 in order to apply the security patch) distributed from a vendor or the like via the network.

Next, in step A1, the management unit 41 stores, to the storage unit 42, the obtained security patch and information regarding the time required for a restart.

Next, the detection unit 11 detects one or more non-use periods using the information regarding the time required for a restart and use history information (step A2).

Specifically, in step A2, the detection unit 11 obtains, from the storage unit 42, the information regarding the time required for a restart. In addition, in step A2, the detection unit 11 obtains, from the storage unit 42, use history information indicating the use histories of the users sharing the target virtual machine 30, and collected by the collecting unit 31.

Next, in step A2, the detection unit 11 detects one or more non-use periods that are equal to or longer than the time required for a restart, and in which none of the users were using the target virtual machine 30, using the information regarding the time required for a restart and the use history information, based on the above method for detecting non-use periods, and the like.

Next, the restart instruction unit 12 sets a restartable period to a period later than the current point of time, based on the detected non-use periods (step A3).

Specifically, in step A3, the restart instruction unit 12 generates restartable period information indicating a restartable period that is set to be a period later than the current point of time, based on the detected non-use periods, and stores the generated restartable period information to the storage unit 42.

As described with reference to FIG. 6, for example, if the common unused period Tc2 is included in the 24-hour period of Monday of the current week, a period later than the current point of time and corresponding to the common unused period Tc2 on Monday of next week is set as a restartable period. It should be noted that there is no limitation to Monday.

Alternatively, for example, if a plurality of periods (non-use periods), within the past one week, in which none of the users sharing the virtual machine 30 is using the virtual machine 30, and that are longer than the time required for a restart are detected, the plurality of detected non-use periods are allocated to corresponding periods of the coming week, based on the day and time, and the periods to which the detected non-use periods are allocated are set as restartable periods.

Next, the restart instruction unit 12 gives an instruction for restarting the target virtual machine 30 in the restartable period (step A4).

Specifically, in step A4, before the set restartable period, the restart instruction unit 12 generates an instruction for applying a security patch to the software of the target virtual machine 30 and for restarting the target virtual machine 30. Next, in step A4, before the set restartable period, the restart instruction unit 12 transmits the generated instruction to the restart execution unit 32 implemented in the virtual machine 30.

Note that, upon receiving the transmitted instruction, the restart execution unit 32 executes a restart of the virtual machine 30 in the restartable period in order to apply the security patch to the software of the virtual machine 30.

The above processing of steps A1 to A4 is executed each time a new security patch is distributed from a vendor. In addition, the above processing of steps A1 to step A4 is executed on all of the virtual machines 30. The users vary for each virtual machine, and thus the restartable period differs for each virtual machine.

### Effect of First Embodiment

As described above, according to the first example embodiment, when a security patch that requires a restart is applied to multi-session software, a restartable period is set based on non-use periods detected using restart required time information (information regarding the time required for a restart) and use history information, and the virtual machine is restarted in the restartable period, thus enabling the virtual machine to be restarted without affecting the users.

[Program]

The program according to the first example embodiment may be a program that causes a computer to execute steps A1 to A4 shown in FIG. 7. By installing this program in a computer and executing the program, the information processing apparatus and the information processing method according to the first example embodiment can be realized. In this case, the processor of the computer functions as the management unit 41, the detection unit 11, the restart instruction unit 12, the collecting unit 31, and the restart execution unit 32, and performs processing.

Also, the program according to the first example embodiment may be executed by a computer system constructed by a plurality of computers. In this case, each computer may function as any of the management unit 41, the detection unit 11, the restart instruction unit 12, the collecting unit 31, and the restart execution unit 32.

### Second Example Embodiment

In a second example embodiment, a method for restarting a virtual machine in order to apply a security patch within a range where use is not affected even when a restartable period cannot be detected and users sharing the virtual machine are using the virtual machine will be described.

[System Configuration]

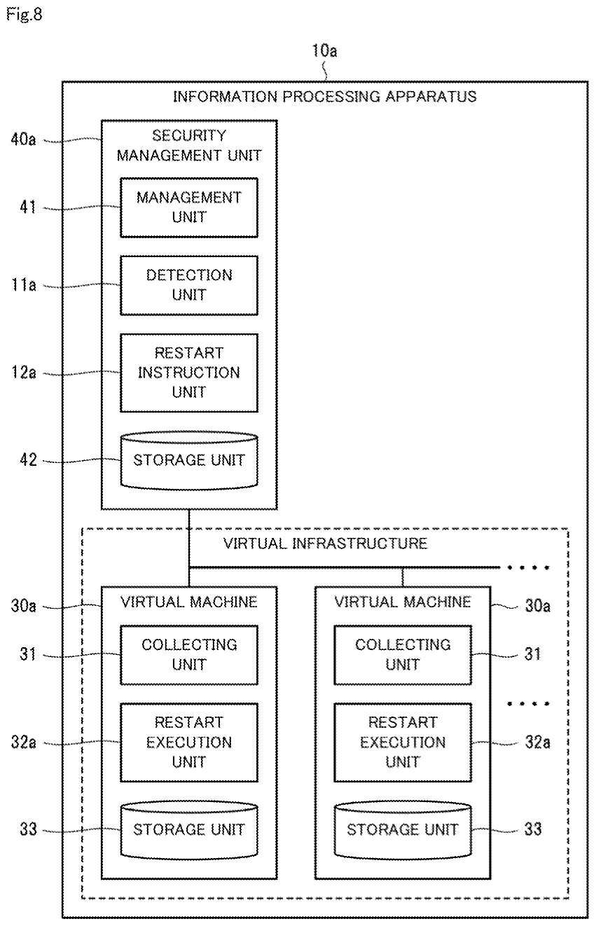

A configuration of an information processing apparatus 10a according to the second example embodiment will be described with reference to FIG. 8. FIG. 8 is a diagram illustrating an example of the information processing apparatus according to the second example embodiment.

In the example in FIG. 8, the information processing apparatus 10a includes one or more virtual machines 30a and a security management unit 40a. In the example in FIG. 8, each of the plurality of virtual machines 30a includes the collecting unit 31, a restart execution unit 32a, and the storage unit 33. The security management unit 40a includes the management unit 41, a detection unit 11a, a restart instruction unit 12a, and the storage unit 42.

Note that, in the example in FIG. 8, the storage unit 33 and the storage unit 42 are separate from each other, but the storage unit 33 and the storage unit 42 may also be one storage unit. Furthermore, in the example in FIG. 8, the storage unit 33 and the storage unit 42 are provided inside the information processing apparatus 10a, but may be provided outside the information processing apparatus 10a.

In addition, in the example in FIG. 8, the collecting unit 31, the restart execution unit 32a, and the storage unit 33 are implemented in each virtual machine 30a, but may be provided outside the virtual machine 30a.

Description of Security Management Unit 40a

The management unit 41 and the storage unit 42 have been described already in the first example embodiment, and thus description of the management unit 41 and the storage unit 42 is omitted.

When each virtual machine 30a needs to be restarted in order to apply a security patch, the detection unit 11a first obtains restart required time information (information regarding the time required for a restart), from the storage unit 42. In addition, the detection unit 11a obtains, from the storage unit 42, use history information of the users sharing each target virtual machine 30a.

Next, the detection unit 11a detects a non-use period that is equal to or longer than the time required for a restart and in which none of the users was using the target virtual machine 30a, using the information regarding the time required for a restart and the use history information. Note that a case where a non-use period was detected has been already described in the first example embodiment, and thus a description thereof is omitted.

Next, when no non-use period can be detected, the detection unit 11a detects one or more suspendable periods that are equal to or longer than the time required for a restart and in which, even if the target virtual machine 30a is being used by any user, use can be suspended, using non-use detection rule information set in advance and the use history information.

The non-use detection rule information is information in which, for each virtual machine 30a, the use specifying information (type information and identification information), the operation identification information, and suspendable use information indicating whether or not use can be suspended are associated with each other. Note that the use specifying information (type information and identification information) and the operation identification information have been described already in the first example embodiment, and thus description of the use specifying information (type information and identification information) and the operation identification information is omitted.

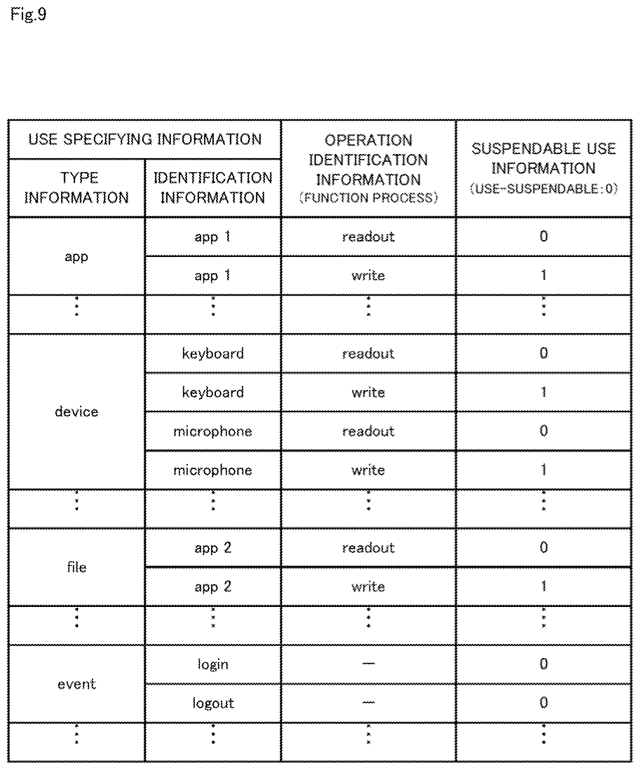

FIG. 9 is a diagram for describing an example of the data structure of the non-use detection rule information. In the example in FIG. 9, the operation identification information stores function processes such as “readout” and “write”. The suspendable use information stores “1” or “0” indicating whether or not use can be suspended. “1” indicates that use cannot be suspended. “0” indicates that use can be suspended.

If, for example, the rule (“app”, “app 1”, “readout”, and “0”) in the first row in the non-use detection rule information in FIG. 9 indicate that use by a user can be suspended when the user is using app 1 and the function process is “readout”.

In addition, the rule (“app”, “app 1”, “write”, and “1”) in the second row of the non-use detection rule information in FIG. 9 indicate that use by the user cannot be suspended when the user is using the app 1 and the function process is “write”.

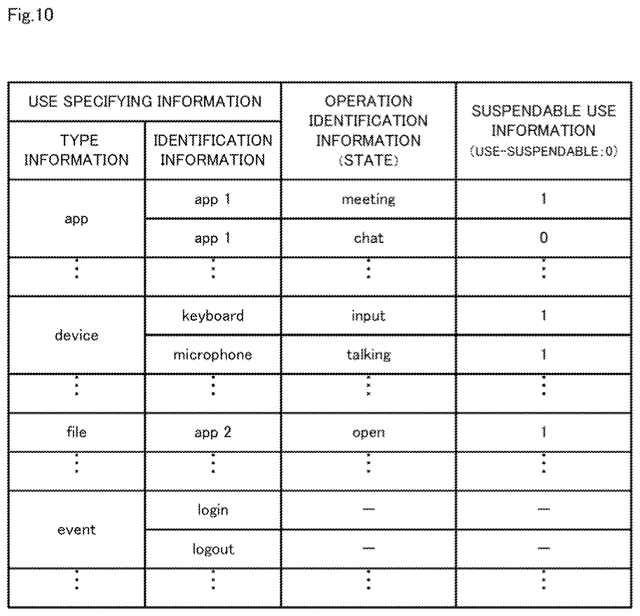

FIG. 10 is a diagram for describing an example of the data structure of the non-use detection rule information. In the example in FIG. 10, the operation identification information stores, as information indicating a state of use, “meeting” indicating that the user is in a meeting, “chat” indicating that the user is chatting online, “input” indicating that the user is key-inputting data, “talking” indicating that the user is talking using a microphone, “open” indicating that a file has been opened by the user, and the like.

In addition, the use-suspendable information stores “1” or “0” indicating whether or not use can be suspended. “1” indicates that use cannot be suspended. “0” indicates that use can be suspended.

The rule (“app”, “app 1”, “meeting”, and “1”) in the first row of the non-use detection rule information in FIG. 10 indicate that use by the user cannot be suspended when the user is in a meeting using the app 1, for example.

The rule (“app”, “app 1”, “chat”, and “0”) in the second row of the non-use detection rule information in FIG. 10 indicate that use by user can be suspended when the user is chatting using the app 1.

A method for detecting a suspendable period will be described.

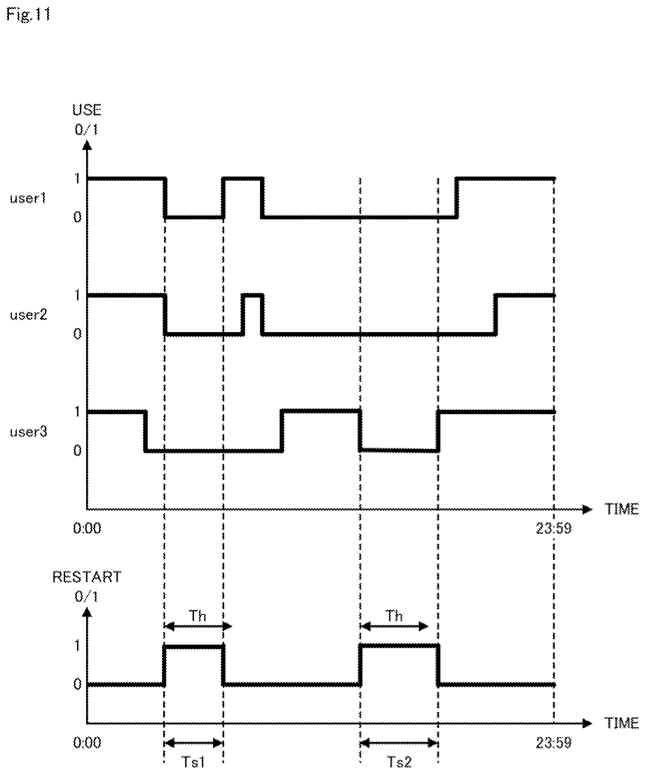

FIG. 11 is a diagram for describing a method for detecting a suspendable period. In the example in FIG. 11, the detection unit 11a references the non-use detection rule information using the use history information of the users (users 1 to 3) that share the virtual machine 30a, and detects one or more periods (suspendable periods) in which uses by the users (users 1 to 3) can be suspended.

Specifically, in the case of the users (users 1 to 3), use periods and suspendable periods of the users (users 1 to 3) within a detection period set in advance are obtained.

In the case of the user (user 1), for example, first, type information, identification information, and operation identification information included in the use history information of the user (user 1) are compared with type information, identification information, and operation identification information included in the non-use detection rule information, and determination is performed as to whether or not the type information, the identification information, and the operation identification information match.

If the type information, the identification information, and the operation identification information match, use period information related to the matched information in the use history information is associated with non-use information related to the matched information in the non-use detection rule information. That is to say, if the non-use information is “0” indicating that use can be suspended, the use period indicated by the use period information is used as a suspendable period. Conversely, if the non-use information is “1” indicating that use cannot be suspended, the use period indicated by the use period information is not used as a suspendable period.

It is conceivable to use, as the detection period, the 24-hour period (0:00 to 23:59) of one of the days in the past one week, for example. In addition, a use period and a suspendable period may be obtained from the past one week.

In addition, also in the case of the users (users 2 and 3), use periods and suspendable periods are obtained similarly to the above user (user 1).

Note that, in the example in FIG. 11, the use periods of the users (users 1 to 3) are indicated by “1”, and the suspendable periods of the users (users 1 to 3) are indicated by “0”.

Next, the detection unit 11a detects a common suspendable period in which the suspendable periods of the users (users 1 to 3) overlap. The example in FIG. 11 indicates that the common suspendable periods Ts1 and Ts2 have been detected.

Next, the detection unit 11a determines whether or not each of the common suspendable periods Ts1 and Ts2 is equal to or longer than the time Th required for a restart. In the example in FIG. 11, the common suspendable period Ts1 is shorter than the time Th required for a restart, and thus is not regarded as a suspendable period. The common suspendable period Ts2 is longer than the time Th required for a restart, and thus is regarded as a suspendable period.

The restart instruction unit 12a first sets a restartable period based on the suspendable period. If the common suspendable period Ts2 is included in the 24-hour period of Monday of the current week, a period later than the current point of time and corresponding to the common suspendable period Ts2 on Monday of next week is set as a restartable period, for example. It should be noted that the day of the week is not limited to Monday.

Next, before the restartable period, the restart instruction unit 12a transmits, to the restart execution unit 32a of the virtual machine 30a, an instruction for applying a security patch to the software of the virtual machine 30a and for restarting the virtual machine 30a.

Note that the non-use detection rule information shown in FIGS. 9 and 10 may be consolidated into one piece of information. In addition, in FIGS. 9 and 10, the non-use information is binary (“0” or “1”) information, but may be a statistical index indicating the influence on a user when use is suspended. It is conceivable that the index has a numerical value of 0.0 to 1.0 in accordance with the degree of influence, for example.

In addition, when an index is used as non-use information, a period in which the total of indexes of all of the users is smaller than or equal to a threshold value set in advance is used as a suspendable period. The threshold value is determined based on testing, simulation, and the like.

Description of Virtual Machine 30a

The collecting unit 31 and the storage unit 33 have been already described in the first example embodiment, and thus description of the collecting unit 31 and the storage unit 33 is omitted.

Before a restartable period, the restart execution unit 32a receives, from the restart instruction unit 12a, an instruction for applying a security patch to the software of the target virtual machine 30a and for restarting the target virtual machine 30a in the restartable period, and applies the security patch and restarts the virtual machine 30a in the restartable period based on the received instruction.

When restarting the target virtual machine 30a, the restart execution unit 32a notifies all of the terminal apparatuses 20 of the users sharing the target virtual machine 30a that the target virtual machine 30a is to be restarted. This is because it is highly likely that the target virtual machine 30a is being used by a user, and thus, it is highly likely that a sudden restart will cause trouble with use. In addition, a notification for requesting that files that are being used be stored may be added to the notification.

### Apparatus Operation in Second Example Embodiment

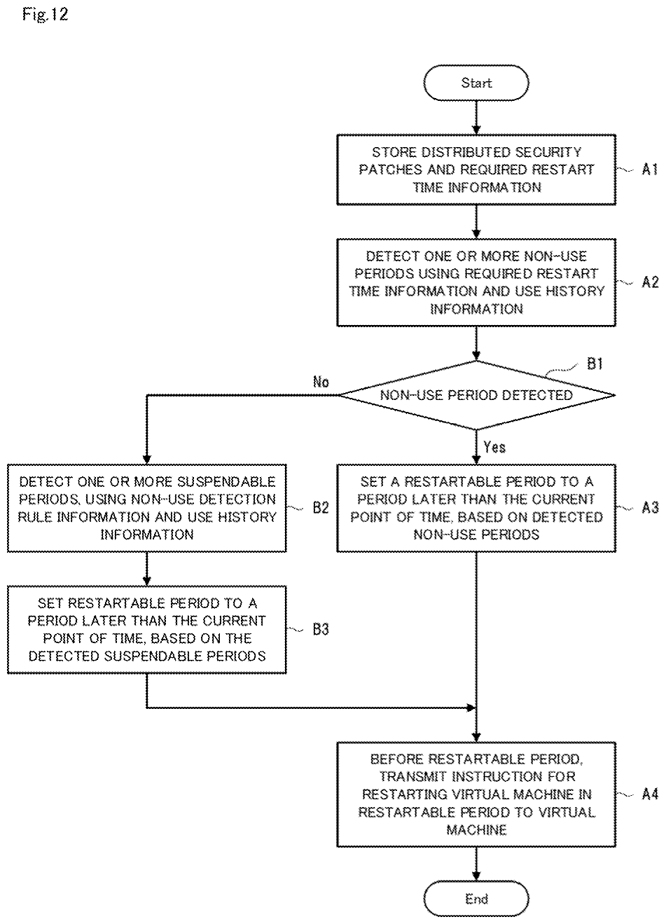

Operations of the information processing apparatus 10a according to the second example embodiment will be described with reference to FIG. 12. FIG. 12 is a diagram for describing operations of the information processing apparatus according to the second example embodiment. In the following description, the diagrams will be referenced as appropriate. In addition, in the second example embodiment, by operating the information processing apparatus, an information processing method is performed. Thus, description of the information processing method according to the second example embodiment is replaced with the following description of operations of the information processing apparatus.

The processing of steps A1 to A4 in FIG. 12 has been already described in the first example embodiment, and thus description of the processing of steps A1 to A4 is omitted.

If no non-use period can be detected (step B1: No), the detection unit 11a detects one or more suspendable periods that are equal to or longer than the time required for a restart and in which, even if a user is using a virtual machine 30a, use by the user can be suspended, using non-use detection rule information and use history information (step B2).

Specifically, in step B2, the detection unit 11a references the non-use detection rule information using the use history information of the users sharing the virtual machines 30a, and detects one or more periods in which uses by the users can be suspended (suspendable periods), based on the above-described method for detecting a suspendable period and the like.

Next, the restart instruction unit 12a sets a restartable period to a period later than the current point of time, based on the detected suspendable periods (step B3).

Specifically, in step B3, the restart instruction unit 12a generates restartable period information indicating the restartable period that is set to a period later than the current point of time, based on the detected suspendable periods, and stores the generated restartable period information to the storage unit 42.

As described with reference to FIG. 11, for example, if the common suspendable period Ts2 is included in the 24-hour period of Monday of the current week, a period later than the current point of time and corresponding to the common suspendable period Ts2 on Monday of next week is set as a restartable period. It should be noted that the day of the week is not limited to Monday.

Alternatively, for example, when a plurality of periods, within the past one week, in which none of all the users sharing a virtual machine 30a is using the virtual machine 30a and that are longer than the time required for a restart (suspendable periods) are detected, the plurality of detected non-use periods are allocated to corresponding periods of the coming one week based on the day and time, and the periods to which the non-use periods are allocated are set as restartable periods.

The processing of steps A1 to A4 and steps B1 to B3 shown in FIG. 12 is executed each time a new security patch is distributed from a vendor. In addition, the above processing of steps A1 to A4 and steps B1 to B3 is executed on all of the virtual machines 30a. Users vary for each of the virtual machines 30a, and thus the restartable period varies for each virtual machine 30a.

### Effects of Second Example Embodiment

As described above, according to the second example embodiment, when a security patch that requires a restart is applied to multi-session software, even when users sharing a virtual machine are using the virtual machine, the virtual machine can be restarted within a range in which use is not affected significantly.

In addition, it is possible lower the cost more by automatically performing determination in a system, than by users adjusting a restart time of the same virtual machine using a communication tool or the like as in a conventional manner.

[Program]

The program according to the second example embodiment may be a program that causes a computer to execute steps A1 to A4 and steps B1 to B3 shown in FIG. 12. By installing this program in a computer and executing the program, the information processing apparatus and the information processing method according to the first example embodiment can be realized. In this case, the processor of the computer functions as the management unit 41, the detection unit 11a, the restart instruction unit 12a, the collecting unit 31, and the restart execution unit 32a, and performs processing.

Also, the program according to the second example embodiment may be executed by a computer system constructed by a plurality of computers. In this case, each computer may function as any of the management unit 41, the detection unit 11a, the restart instruction unit 12a, the collecting unit 31, and the restart execution unit 32a.

[Physical Configuration]

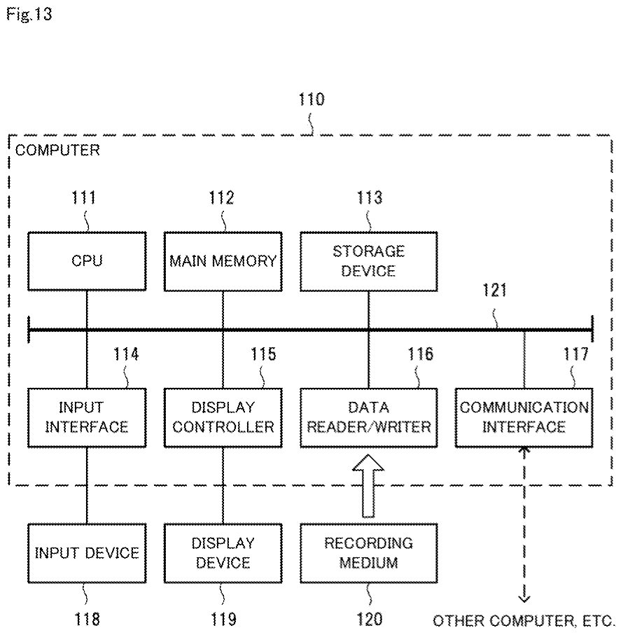

Here, a computer that executes a program according to the first and second example embodiments to realize an information processing apparatus will be described with reference to FIG. 13. FIG. 13 is a diagram for describing an example of a computer that realizes the information processing apparatus the information processing apparatus according to the first and second example embodiments.

As shown in FIG. 13, a computer 110 includes a CPU 111, a main memory 112, a storage device 113, an input interface 114, a display controller 115, a data reader/writer 116, and a communication interface 117. These units are connected via bus 121 so as to be able to perform data communication with each other. Note that the computer 110 may include a GPU (Graphics Processing Unit) or a FPGA (Field-Programmable Gate Array) in addition to the CPU 111 or instead of the CPU 111.

The CPU 111 loads a program (codes) according to the present exemplary embodiment stored in the storage device 113 to the main memory 112, and executes them in a predetermined order to perform various kinds of calculations. The main memory 112 is typically a volatile storage device such as a DRAM (Dynamic Random Access Memory). Also, the program according to the present exemplary embodiment is provided in the state of being stored in a computer-readable recording medium 120. Note that the program according to the present exemplary embodiment may be distributed on the Internet that is connected via the communication interface 117.

Specific examples of the storage device 113 include a hard disk drive, and a semiconductor storage device such as a flash memory. The input interface 114 mediates data transmission between the CPU 111 and the input device 118 such as a keyboard or a mouse. The display controller 115 is connected to a display device 119, and controls the display of the display device 119.

The data reader/writer 116 mediates data transmission between the CPU 111 and the recording medium 120, and reads out the program from the recording medium 120 and writes the results of processing performed in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

The information processing apparatus according to the first and second example embodiment can also be achieved using hardware corresponding to the components, instead of a computer in which a program is installed. Furthermore, a part of the information processing apparatus may be realized by a program and the remaining part may be realized by hardware.

Although the invention of this application has been described with reference to the example embodiment, the invention of this application is not limited to the above example embodiment. Within the scope of the invention of this application, various changes that can be understood by those skilled in the art can be made to the configuration and details of the invention of this application.

As described above, according to the present disclosure, when a security patch that requires a restart is applied to software that supports the multi-session model, influence on users can be reduced. In addition, it is useful in a technical field in which restarting of virtual machines is required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
a detection unit that detects, when a computer needs to be restarted in applying a security patch to software that supports a multi-session model and is accessed and used by a plurality of users, one or more non-use periods that are equal to or longer than a time required for the restart and in which none of the users are using the computer, using information regarding the time required for the restart and use history information indicating use histories of the respective users of the computer; and
a restart instruction unit that sets a restartable period to a period later than a current point of time based on the detected one or more non-use periods, and gives an instruction for restarting the computer in the restartable period.

2. The information processing apparatus according to claim 1,
wherein the use history information is information in which user identification information for identifying the users, use specifying information for specifying use, use period information indicating a period of use, and operation identification information for identifying an operation performed in use are associated with each other.

3. The information processing apparatus according to claim 2,
wherein, when the unused period cannot be detected, the detection unit further detects one or more suspendable periods that are equal to or longer than the time required for the restart and during which, even if the computer is being used by any of the users, use by the users is suspendable at the same time, using non-use detection rule information set in advance and the use history information.

4. The information processing apparatus according to claim 3,
wherein the restart instruction unit further sets a restartable period to a period later than the current point of time, based on the detected one or more suspendable periods, and gives an instruction for restarting the computer in the restartable period.

5. The information processing apparatus according to claim 4,
wherein the non-use detection rule information is information in which the use specifying information, the operation identification information, and suspendable use information indicating whether or not use is suspendable are associated with each other.

6. The information processing apparatus according to claim 4,
wherein the non-use detection rule information is information in which the use specifying information, the operation identification information, and suspendable use information that is an index indicating influence on the user when use is suspended are associated with each other.

7. The information processing apparatus according to claim 5,
wherein the operation identification information is information indicating a function process corresponding to use.

8. The information processing apparatus according to claim 5,
wherein the operation identification information is information indicating a state of use.

9. The information processing apparatus according to claim 6,
wherein the operation identification information is information indicating a function process corresponding to use.

10. The information processing apparatus according to claim 6,
wherein the operation identification information is information indicating a state of use.

11. An information processing method that is performed by an information processing apparatus, the method comprising:
detecting, when a computer needs to be restarted in applying a security patch to software that supports a multi-session model and is accessed and used by a plurality of users, one or more non-use periods that are equal to or longer than a time required for the restart and during which none of the users are using the computer, using information regarding the time required for the restart and use history information indicating use statuses of the respective users of the computer; and
setting a restartable period to a period later than a current point of time based on the detected one or more non-use periods, and giving an instruction for restarting the computer in the restartable period.

12. A non-transitory computer-readable recording medium that includes a program recorded thereon, the program including instructions that causes a computer to carry out the steps of:
detecting, when a computer needs to be restarted in applying a security patch to software that supports a multi-session model and is accessed and used by a plurality of users, one or more non-use periods that are equal to or longer than a time required for the restart and in which none of the users are using the computer, using information regarding the time required for the restart and use history information indicating use statuses of the respective users of the computer; and
setting a restartable period to a period later than the current point of time based on the detected one or more non-use periods, and giving an instruction for restarting the computer in the restartable period.
